(19) United States
(12) Patent Application Publication
(10) Pub. No.: US 2018/0005313 A1
(43) Pub. Date: Jan. 4, 2018

(54) Method and System for Determining a New Location for a Merchant

(71) Applicant: MASTERCARD INTERNATIONAL INCORPORATED, Purchase, NY (US)

(72) Inventors: Mrinal Gupta, Alwar (IN); Vikhyat Shukla, Gurgaon (IN); Lokesh Rajput, Gurgaon (IN)

(21) Appl. No.: 15/636,740

(22) Filed: Jun. 29, 2017

(30) Foreign Application Priority Data
Jun. 30, 2016 (SG) 10201605396R

(51) Int. Cl. G06Q 30/06; G06Q 10/08; G06Q 10/06

(52) U.S. Cl. CPC G06Q 30/0643; G06Q 30/0639; G06Q 30/0605; G06Q 10/06; G06Q 10/06315; G06Q 10/0631; G06Q 10/08

(57) ABSTRACT

A computer-implemented method is proposed for determining a new location for a merchant. The method comprises: a) obtaining transaction data for a plurality of cardholders; b) obtaining location data for said cardholders; c) combining the location data with the transaction data; d) analyzing the locations of cardholders performing transactions at a particular merchant or type of merchant to determine any localities within which multiple cardholders performing such transactions are located; and e) assessing such localities on the basis of one or more economic factors to determine whether to recommend said locality as a new location for the merchant or type of merchant.

### CROSS-REFERENCE TO RELATED APPLICATION

This application claims the benefit of and priority to Singapore Patent Application No. 10201605396R, filed Jun. 30, 2016. The entire disclosure of the above application is incorporated herein by reference.

### FIELD

The present disclosure generally relates to a method and system for determining a new location for a merchant.

### BACKGROUND

This section provides background information related to the present disclosure which is not necessarily prior art.

Currently, merchants do not tend to have access to data concerning where their customers live. It is therefore difficult for merchants to determine where to open new stores or even the best location for their existing stores.

Although economic data can be obtained regarding the growth of a country or region, it is often not available on a local level and therefore it can also be difficult for businesses to identify up-and-coming areas in which to open stores.

It is therefore an aim of the present disclosure to provide an improved method and system for determining a new location for a merchant.

### SUMMARY

This section provides a general summary of the disclosure, and is not a comprehensive disclosure of its full scope or all of its features. Aspects and embodiments of the disclosure are set out in the accompanying claims.

In accordance with a first aspect of the disclosure there is provided a computer-implemented method for determining a new location for a merchant comprising:
(i) obtaining, by an analysis component, transaction data for a plurality of cardholders;
(ii) obtaining, by the analysis component, location data for said cardholders;
(iii) combining, by the analysis component, the location data with the transaction data;
(iv) analysing, by the analysis component, the locations of cardholders performing transactions at a particular merchant or type of merchant to determine any localities within which multiple cardholders performing such transactions are located; and
(v) assessing, by the analysis component, such localities on the basis of one or more economic factors to determine whether to recommend said locality as a new location for the merchant or type of merchant.

Thus, embodiments of the disclosure provide a computerised method for discovering, assessing and recommending a new location for a merchant based both on a spending analysis of individual customers in that location and economic factors concerning that location. In other words, embodiments of the disclosure may quickly identify up-and-coming locations for businesses that wish to expand to more locations.

The location data may comprise one or more of zip codes, addresses, street names, towns, regions or areas. The location data may relate to a cardholder's place of residence or to a place the cardholder frequently visits (e.g. a workplace).

The transaction data may comprise time, date, transaction amount, merchant location, merchant ID, customer ID and also product purchase information comprising product ID, number of products purchased and the quantity and cost of each product purchased.

The analysis of step (iv) may determine how many cardholders from a particular location have transactions with the merchant or merchant type (i.e. the footfall or density of customers in the locality). Furthermore, the analysis of step (iv) may take into account the ticket size (i.e. transaction amounts) by individual cardholders and may prioritise localities with higher average transaction amounts than others.

The analysis of step (iv) may comprise determining the frequency of transactions from cardholders in different locations.

The analysis of step (iv) may comprise determining how long a cardholder has been a customer of a merchant (e.g. to assess customer loyalty).

The analysis of step (iv) may also take into account daily, weekly, monthly, seasonal or annual variations by segmenting the transaction data based on the time of the transactions.

The type of merchant may be by industry (e.g. grocery, pharmacy, entertainment, supermarket, restaurant, bar) and may be further categorised as appropriate (e.g. Chinese, Italian or Indian restaurant).

The economic factors may comprise information about the economic growth of the country, locality, merchant or industry. The merchant growth may be compared to the industry growth. The growth in the locality may be compared to the growth in the country. The comparisons may result in at par growth; above par growth or below par growth levels.

In some embodiments, the analysis of step (v) may comprise business survival analysis (e.g. taking into account economic factors in addition to customer footfall and geography).

Statistical techniques may be employed (e.g. a maximum likelihood technique) to predict the suitability of a potential location for a merchant in terms of anticipated growth, customer spend and footfall.

Embodiments of the disclosure may help merchants to position themselves in the right location at the right time (i.e. when all of the contributing factors predict a favourable outcome).

As used herein, the term “products” may comprise any goods or services.

As used in this document, the term “payment card” refers to any suitable cashless payment device, such as a credit card, a debit card, a prepaid card, a charge card, a membership card, a promotional card, a frequent flyer card, an identification card, a gift card, and/or any other device that may hold payment account information, such as mobile phones, Smartphones, personal digital assistants (PDAs), key fobs, transponder devices, NFC-enabled devices, tablets and/or computers.

The step of obtaining transaction data may comprise reading data from a transaction database.

The step of obtaining location data may comprise reading data from a location database.

In some embodiments, the data may be stored remotely and may be accessible via a cloud server.

In accordance with a second aspect of the disclosure there is provided a computer system for determining a new location for a merchant comprising:
(i) a transaction database comprising transaction data for a plurality of cardholders;
(ii) a location database comprising location data for said cardholders; and
(iii) an analysis component communicatively coupled with the transaction database and the location database, and being configured for:
   a. combining the location data with the transaction data;
   b. analysing the locations of cardholders performing transactions at a particular merchant or type of merchant to determine any localities within which multiple cardholders performing such transactions are located; and
   c. assessing such localities on the basis of one or more economic factors to determine whether to recommend said locality as a new location for the merchant or type of merchant.

The analysis component could be specific-purpose hardware, or a software component stored on storage of a server.

The disclosure may be implemented in the form of a centralised computer system which presents an interface to which operators may connect (e.g. over the internet).

The optional method features described above may be implemented using the computer system according to the second aspect of the disclosure.

In accordance with a third aspect of the disclosure there is provided a non-transitory computer-readable medium having stored thereon program instructions for causing at least one processor to perform the method according to the first aspect of the disclosure.

Further areas of applicability will become apparent from the description provided herein. The description and specific examples and embodiments in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. Embodiments of the disclosure will now be described, by way of example only, with reference to the following drawings, in which:

FIG. 1 is a flowchart of a method according to an embodiment of the present disclosure;

FIG. 2 is a block diagram of a computer system according to an embodiment of the present disclosure; and

FIG. 3 is a block diagram of the technical architecture of the server of FIG. 2.

Corresponding reference numerals indicate corresponding parts throughout the several views of the drawings.

### DETAILED DESCRIPTION

Embodiments of the present disclosure will be described, by way of example only, with reference to the drawings. The description and specific examples included herein are intended for purposes of illustration only and are not intended to limit the scope of the present disclosure.

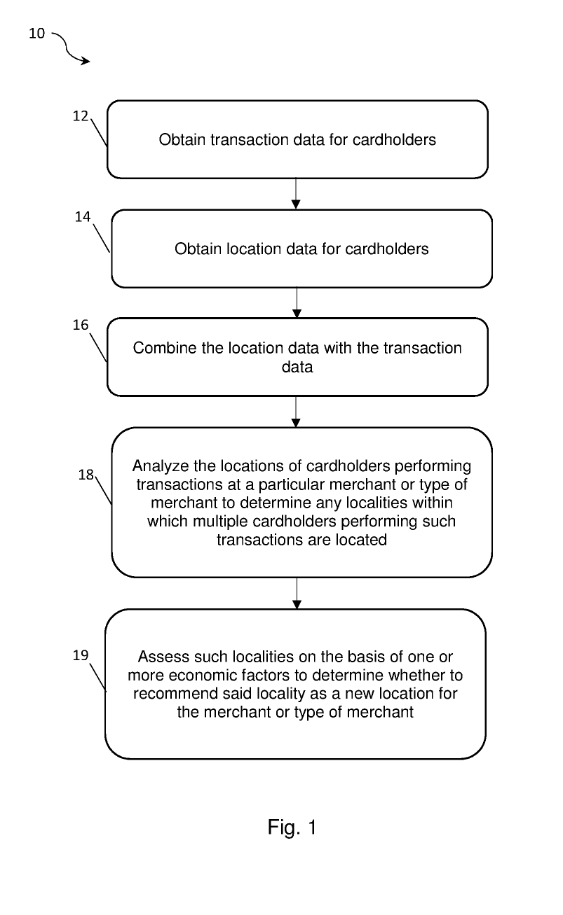

In accordance with an embodiment of the present disclosure there is provided a computer-implemented method 10 for determining a new location for a merchant, as illustrated in FIG. 1. In particular, the method comprises the following steps:
Step 12: obtaining transaction data for a plurality of cardholders;
Step 14: obtaining location data for said cardholders;
Step 16: combining the location data with the transaction data;
Step 18: analysing the locations of cardholders performing transactions at a particular merchant or type of merchant to determine any localities within which multiple cardholders performing such transactions are located; and
Step 19: assessing such localities on the basis of one or more economic factors to determine whether to recommend said locality as a new location for the merchant or type of merchant.

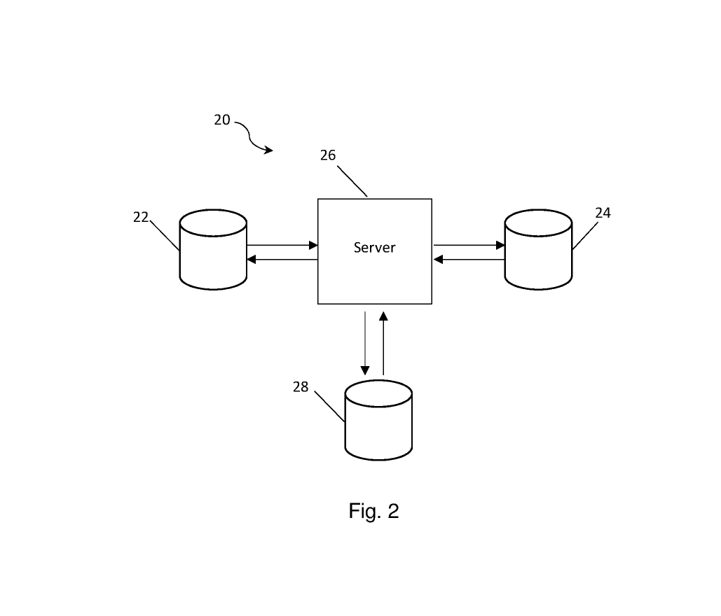

FIG. 2 shows a block diagram of a computer system 20 according to an embodiment of the present disclosure. The computer system 20 is configured for determining a new location for a merchant, in accordance with the method described above, and comprises a transaction database 22, a location database 24 and a server 26. The database 22 comprises transaction data for a plurality of cardholders. The database 24 comprises location data for said cardholders. The server 26 comprises an analysis component configured for a) combining the location data with the transaction data; b) analysing the locations of cardholders performing transactions at a particular merchant or type of merchant to determine any localities within which multiple cardholders performing such transactions are located; and c) assessing such localities on the basis of one or more economic factors to determine whether to recommend said locality as a new location for the merchant or type of merchant. The economic factors may be stored and retrieved by the server 26 from an economy database 28.

Although not shown, the computer system 20 may further comprise a GUI for presenting information to an operator. Furthermore, the computer system 20 may comprise a distributed system with one or more components (e.g. databases) distributed over a network (i.e. the internet).

As explained above, embodiments of the present disclosure have the advantage that up-and-coming locations for businesses can be identified based both on a spending analysis of individual customers in that location and economic factors concerning that location.

In the embodiment illustrated, the location data comprises address information, including zip codes, for cardholder places of residence. Such information may be obtained from third party vendors.

The transaction data is obtained from a card issuer and comprises time, date, transaction amount, merchant location, merchant ID and customer ID. The customer ID must be sufficient for the system to identify the cardholder's zip code from the location data. In some embodiments, the customer ID may be cardholder's name. In addition, itemised product purchase information may be obtained from the merchants including product ID, number of products purchased and the quantity and cost of each product purchased.

The analysis includes filtering the data to determine how many cardholders from a particular location have transactions with a particular merchant or merchant type (e.g. café, grocery store, clothing store etc.). Furthermore, the analysis takes into account the transaction amounts by individual cardholders and prioritises localities with higher than average transaction amounts than others.

The analysis also comprises determining the frequency of transactions from cardholders in different locations as well as determining how long a cardholder has been a customer of a merchant to assess customer loyalty.

The economic factors may be obtained from a third party database and may comprise information about the economic growth of the country, locality, merchant or industry. The merchant growth may be compared to the industry growth and the growth in the locality may be compared to the growth in the country. The comparisons may result in at par growth; above par growth or below par growth levels.

In some embodiments, the analysis may comprise known survival analysis methodology to determine the likely success of a business in the identified new location. For example, a maximum likelihood technique may be employed to predict the suitability of a potential location for a merchant in terms of anticipated economic growth, customer spend and footfall.

Embodiments of the disclosure can therefore help merchants to position themselves in the right location at the right time.

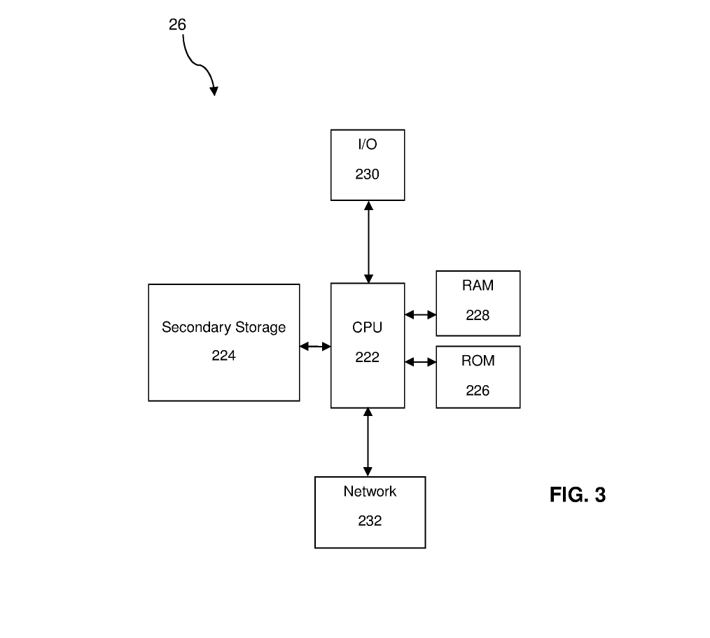

FIG. 3 is a block diagram showing a technical architecture of the server 26. The technical architecture includes a processor 222 (which may be referred to as a central processor unit or CPU) that is in communication with memory devices including secondary storage 224 (such as disk drives), read only memory (ROM) 226, random access memory (RAM) 228. The processor 222 may be implemented as one or more CPU chips. The technical architecture may further comprise input/output (I/O) devices 230, and network connectivity devices 232.

The secondary storage 224 is typically comprised of one or more disk drives or tape drives and is used for non-volatile storage of data and as an over-flow data storage device if RAM 228 is not large enough to hold all working data. Secondary storage 224 may be used to store programs which are loaded into RAM 228 when such programs are selected for execution.

In this embodiment, the secondary storage 224 comprises non-transitory instructions operative by the processor 222 to perform various operations of the method of the present disclosure. The ROM 226 is used to store instructions and perhaps data which are read during program execution. The secondary storage 224, the RAM 228, and/or the ROM 226 may be referred to in some contexts as computer readable storage media and/or non-transitory computer readable media.

I/O devices 230 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Although the technical architecture is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture to provide the functionality of a number of servers that is not directly bound to the number of computers in the technical architecture. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It is understood that by programming and/or loading executable instructions onto the technical architecture, at least one of the CPU 222, the RAM 228, and the ROM 226 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Although only a single system and method according to embodiments of the present disclosure have been described in detail, many variations are possible in accordance with the appended claims.

With that said, and as described, it should be appreciated that one or more aspects of the present disclosure transform a general-purpose computing device into a special-purpose computing device when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein. What's more, a computing device as used herein may include a single computing device or multiple computing devices.

In addition, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for determining a new location for a merchant, the method comprising:
(i) obtaining, by an analysis component, transaction data for a plurality of cardholders;
(ii) obtaining, by the analysis component, location data for said cardholders;
(iii) combining, by the analysis component, the location data with the transaction data;
(iv) analyzing, by the analysis component, the locations of cardholders performing transactions at a particular merchant or type of merchant to determine any localities within which multiple cardholders performing such transactions are located; and
(v) assessing, by the analysis component, such localities on the basis of one or more economic factors to determine whether to recommend said locality as a new location for the merchant or type of merchant.

2. The method according to claim 1, wherein analyzing the locations comprises determining how many cardholders from a particular location have transactions with the merchant or merchant type.

3. The method according to claim 1, wherein analyzing the locations takes into account the transaction amounts by individual cardholders and prioritizes localities with higher average transaction amounts than others.

4. The method according to claim 1, wherein analyzing the locations comprises determining the frequency of transactions from cardholders in different locations.

5. The method according to claim 1, wherein analyzing the locations comprises determining how long a cardholder has been a customer of the merchant or merchant type.

6. The method according to claim 1, wherein analyzing the locations takes into account daily, weekly, monthly, seasonal or annual variations by segmenting the transaction data based on the time of the transactions.

7. The method according to claim 1, wherein the type of merchant is categorized by industry.

8. The method according to claim 1, wherein the economic factors comprise information about the economic growth of the country, locality, merchant or industry.

9. The method according to claim 8, wherein the merchant growth is compared to the industry growth.

10. The method according to claim 8, wherein the growth in the locality is compared to the growth in the country.

11. The method according to claim 1, wherein analyzing the locations the comprises survival analysis.

12. The method according to claim 1, further comprising employing wherein statistical techniques to predict the suitability of a potential location for a merchant in terms of anticipated growth, customer spend and footfall.

13. The method according to claim 1, wherein obtaining transaction data comprises reading data from a transaction database.

14. The method according to claim 1, wherein obtaining location data comprises reading data from a location database.

15. The method according to claim 1, wherein the location data comprises one or more of: zip codes, addresses, street names, towns, regions or areas.

16. The method according to claim 1, wherein the transaction data comprises one or more of: time, date, transaction amount, merchant location, merchant ID, customer ID, product purchase information, product ID, number of products purchased; the quantity and/or cost of each product purchased.

17. A computer system for determining a new location for a merchant, the computer system comprising:
(i) a transaction database comprising transaction data for a plurality of cardholders;
(ii) a location database comprising location data for said cardholders; and
(iii) an analysis component communicatively coupled with the transaction database and the location database, the analysis component configured to:
a. combine the location data with the transaction data;
b. analyze the locations of cardholders performing transactions at a particular merchant or type of merchant to determine any localities within which multiple cardholders performing such transactions are located; and
c. assess such localities on the basis of one or more economic factors to determine whether to recommend said locality as a new location for the merchant or type of merchant.

18. A non-transitory computer-readable storage medium having stored thereon program instructions, which when executed by at least one processor, cause the at least one processor to:
obtain transaction data for a plurality of cardholders;
obtain location data for said cardholders;
combine the location data with the transaction data;
analyze the locations of cardholders performing transactions at a particular merchant or type of merchant to determine any localities within which multiple cardholders performing such transactions are located; and
assess such localities on the basis of one or more economic factors to determine whether to recommend said locality as a new location for the merchant or type of merchant.
